(19) United States
(12) Patent Application Publication
(10) Pub. No.: US 2004/0217758 A1
(43) Pub. Date: Nov. 4, 2004

(54) Electromagnetic shaft position sensor and method

(76) Inventor: John R. Leonard, Glendale, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/428,625

(22) Filed: May 2, 2003

(51) Int. Cl. G01B 7/30

(52) U.S. Cl. 324/207.2; 324/207.25

(57) ABSTRACT

A rotational position sensing system includes a rotor, one or more magnets, a stators and at least two magnetic field sensors. The stator has an inner surface and surrounds at least a portion of an outer surface of the rotor. The stator inner surface is spaced-apart from the rotor outer surface to form a gap therebetween. The magnets are coupled to, and circumscribe at least a section of, either the rotor outer surface or the stator inner surface. The magnetic field sensors are disposed at least partially in the gap and are positioned at a predetermined angle relative to one another. The sensors detect variations in magnetic field flux as the rotor and stator rotate relative to one another and supply signals that are processed to determine the rotational position of the rotor relative to the stator.

### FIELD OF THE INVENTION

The present invention generally relates to a position sensor and, more particularly, to a position sensor that senses the angular position of a rotating element relative to a another element.

### BACKGROUND OF THE INVENTION

Various systems and devices include one or more rotating components. In many of these systems and devices, it is desirable to determine the rotational position of one or more of the rotating components relative to one or more other components. For example, in a brushless DC motor, it is desirable to determine the position of the rotor with respect to the stator in order to appropriately effect commutation.

Various position sensors have been used to determine the relative rotational position of a rotating element. Included among these sensors are potentiometers, resolvers, and encoders. Although each of these types of sensors functions generally satisfactorily, and is generally safe and reliable, each exhibits certain drawbacks. For example, potentiometers, while being relatively inexpensive, can generate debris and can suffer from relatively short lifecycle times. In some instances, a relatively moderate lead time (e.g., up to 18 weeks or more) can be experienced between the time a potentiometer is ordered and the time it is received for installation. In addition, some potentiometer designs can suffer relatively short lifecycle times.

Resolvers and encoders also suffer drawbacks similar to potentiometers. For example, both resolvers and encoders can be relatively costly to manufacture and install, and a relatively long lead time (e.g., up to 36 weeks or more for resolvers and up to 52 weeks or more for encoders) can be experienced. In addition, these types of sensors may need some fairly complex signal processing and/or transmission circuitry to fully implement a suitably accurate position sensing scheme. These additional circuits can further increase costs associated with the position sensing implementation.

Hence, there is a need for a system and method of determining the relative rotational position of a rotating element that is less costly as compared to certain known position sensing systems and methods, and/or that has a relatively short lead time to implement as compared to certain known systems and methods, and/or that has a relatively long lifecycle time as compared to certain known systems and methods, and/or that does not require relatively complex signal processing circuitry. The present invention addresses one or more of these needs.

### BRIEF SUMMARY OF THE INVENTION

In one embodiment, and by way of example only, a rotational position sensing system includes a rotor, a stator, one or more magnets, and at least two magnetic field sensors. The rotor has at least an outer surface. The stator has at least an inner surface and surrounds at least a portion of the rotor outer surface. The stator inner surface is spaced-apart from the rotor outer surface to form a gap therebetween. The magnets are coupled to, and circumscribe at least a section of, either the rotor outer surface or the stator inner surface, to thereby generate a magnetic field in the gap. The magnetic field sensors are disposed at least partially in the gap and are positioned at a predetermined angle relative to one another.

In another exemplary embodiment, a rotational position sensing system includes a rotor, a stator, a permanent magnet, and at least two magnetic field sensors. The rotor has at least an outer surface. The stator has at least an inner surface and surrounds at least a portion of the rotor outer surface. The stator inner surface is spaced-apart from the rotor outer surface to form a gap therebetween. The permanent magnet is coupled to, and circumscribes—at least a section of, either the rotor outer surface or the stator inner surface, and is magnetized across its diameter, thereby generating a magnetic field in the gap. The magnetic field sensors are disposed at least partially in the gap and are positioned at a predetermined angle relative to one another.

In yet another exemplary embodiment, a method of determining a rotational position of a rotating element includes coupling one or more magnets to, and circumscribing at least a portion of, a first element that is configured to rotate. The magnets are surrounded with a second element that is spaced-apart from the first element to form a gap therebetween. Magnetic field flux magnitude variations are sensed at least at two positions in the gap when the first element rotates relative to the second element.

### BRIEF DESCRIPTION OF THE DRAWINGS

The present invention will hereinafter be described in conjunction with the following drawing figures, wherein like numerals denote like elements, and wherein:

FIG. 1 is an end view of a position sensing system according to an exemplary embodiment of the present invention;

FIG. 2 is a perspective view of a portion of the position sensing system shown in FIG. 1;

FIGS. 3A & 3B depict various exemplary magnet configurations that may be used with the position sensing system shown in FIG. 1;

FIG. 4 is an alternative position sensing system that includes the magnet depicted in FIG. 3B;

FIG. 5 shows the magnetic flux field through various components of the position sensing system of FIG. 1;

FIG. 6 is a graph depicting magnetic flux density versus rotational position for the position sensing systems illustrated in FIGS. 1 and 4; and

FIG. 7 is a graph depicting the output signal variations from the sensors used in the system of FIG. 1

### DETAILED DESCRIPTION OF PREFERRED EMBODIMENTS

The following detailed description of the invention is merely exemplary in nature and is not intended to limit the invention or the application and uses of the invention. Furthermore, there is no intention to be bound by any theory presented in the preceding background of the invention or the following detailed description of the invention.

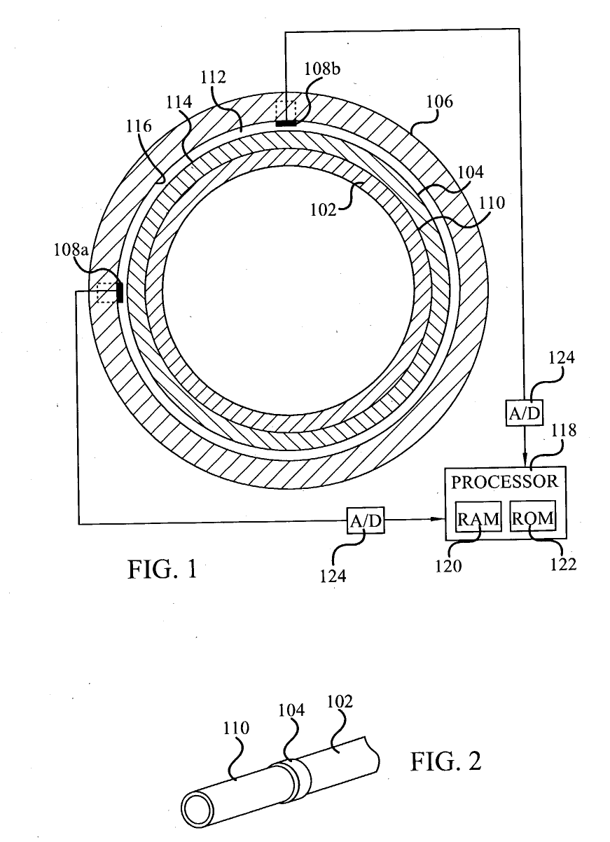

A simplified schematic representation of an exemplary embodiment of a rotational position sensing system is illustrated in FIG. 1. The system 100 includes a rotating element (or rotor) 102, a magnet 104, a stationary element (or stator) 106, and two or more sensors 108. The rotor 102 is the element whose relative rotational position is being sensed. In particular, it is the relative position of the rotor 102 with respect to the stator 106 that is being sensed. Thus, the rotor 102 is configured to rotate relative to the stator 106 in either the clockwise (CW) or counter-clockwise (CCW) direction (as viewed from the perspective of FIG. 1). The rotor 102 is formed of a magnetically permeable material and, although it is shown as being substantially hollow, it will be appreciated that this is merely exemplary of a particular preferred embodiment and that the rotor 102 could be solid. Non-limiting exemplary materials of which the rotor 102 could be formed include a 50% NiFe alloy, 416 stainless steel, and carbon steel alloy.

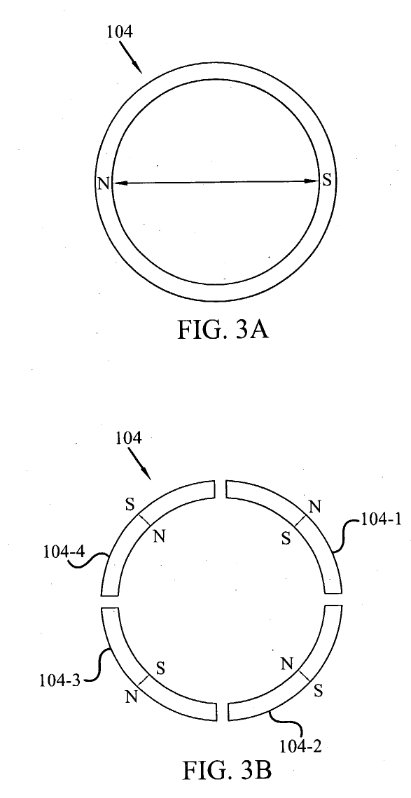

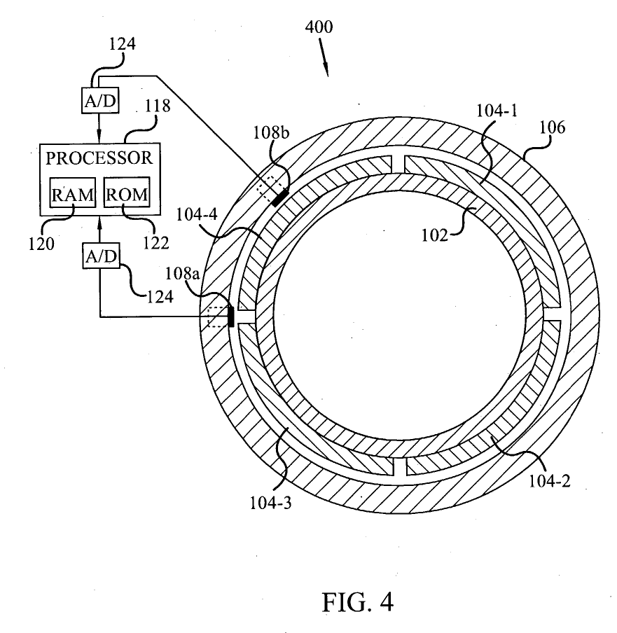

The magnet 104 is coupled to the rotor 102 and, as shown more clearly in FIG. 2, circumscribes a section of the rotor 102. The magnet 104 may be configured to have one or more magnetic pole pairs, and may be implemented as a unitary structure or as a plurality of magnetic structures. In particular, as shown FIG. 3A, the magnet 104 is implemented as a unitary structure that is magnetized across its diameter, and thus has a single pole pair. Alternatively, as shown in FIG. 3B, the magnet 104 could be implemented as four separate structures 104-1, 104-2, 104-3, 104-4 each having a single pole pair, but each being radially magnetized. Thus, to the sensors 108, the magnets 104-1, 104-2 effectively exhibit two pole pairs. The magnet 104 in FIG. 3B could be implemented as a unitary structure or as, for example, four individual magnets that each circumscribe a 90 degree arc around the rotor 102. An exemplary rotational position sensing system 100 configured with the magnet of FIG. 3B is shown in FIG. 4. It will be appreciated that the magnet 104 is not limited to the configurations illustrated in FIGS. 3A and 3B. Indeed, the magnet 104 could be configured to include any one of numerous numbers of appropriately magnetized magnets (e.g., 104-1, 104-2, 104-3, . . . 104-N) that each circumscribe a predetermined, evenly spaced arc around the rotor 102. With N-number of appropriately magnetized magnets 104-1, 104-2, 104-3, . . . 104-N, each preferably having a single pole pair, the magnet 104 as a whole would be seen by the sensors as having N poles, and N/2 pole pairs. It will additionally be appreciated that each magnet 104 could be coupled to an outer surface 110 of the rotor 102, embedded completely or partially within the rotor 102, or form an integral part of the rotor 102. Moreover, while the magnet 104 is depicted as being coupled to the rotor 102, it will be appreciated that the magnet 104 could also be coupled to the stator 106.

Turning back to FIG. 1, the stator 106 surrounds at least the magnet 104, and is spaced apart from the magnet 104 to form a gap 112 between an outer surface 114 of the magnet 104 and an inner surface 116 of the stator 106. The stator 106 is preferably configured to remain in a fixed position relative to the rotor 102, when the rotor 102 rotates. However, it will be appreciated that the stator 106 could be configured to rotate, so long as a relative rotation exists between the rotor 102 and stator 106, and the rate of rotation of at least the stator 106 is known. As with the rotor 102, the stator 106 is formed of a magnetically permeable material such as, for example, at least those non-limiting exemplary materials mentioned above. Moreover, in a particular preferred embodiment, the stator 106 is formed of a plurality of magnetically permeable laminations. Forming the stator 106 of a plurality of laminations reduces eddie current generation in the stator 106. Eddie currents can result in drag being generated between the rotor 102 and stator 106.

The sensors 108 are disposed at least partially in the gap 112 between the rotor 102 and the stator 106. In the depicted embodiment, a single pair of sensors, which includes a first sensor 108a and a second sensor 108b, is used and each sensor of the pair is positioned in space quadrature (e.g., 90-degrees electrical) with respect to one another. It will be appreciated that more than one pair of sensors 108 could be used to provide electrical redundancy. Each sensor 108 may be disposed in the gap 112 using any one of numerous methods. For example, the sensors 108 could be coupled to the stator inner surface 116, as shown in FIG. 1. Alternatively, the sensors 108 could be positioned in sensor receptacles (shown in phantom in FIG. 1) formed in the stator 102, or held in place in the gap 112 using sensor mounts or housings that are coupled to other suitable structure. The sensors 108 may be any one of numerous types of devices that are sensitive to magnetic field flux variations such as, for example, a linear, analog Hall effect sensor.

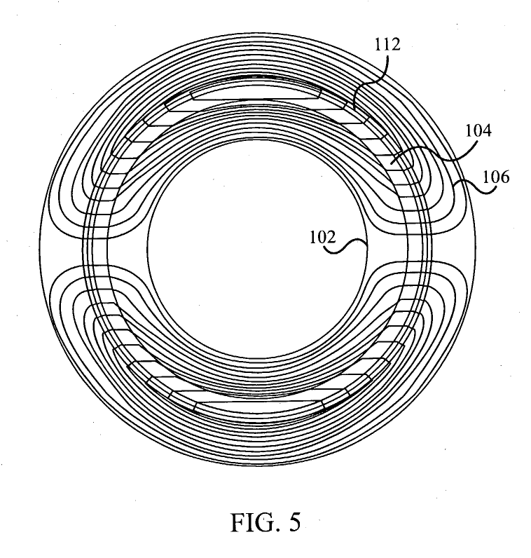

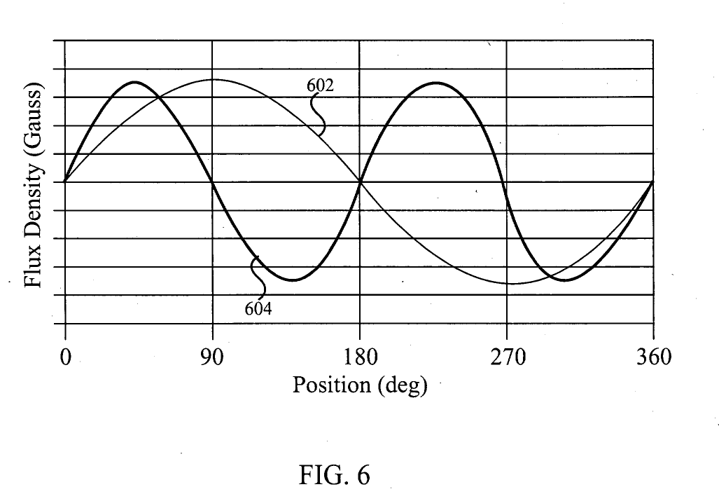

With the above-described configuration, a magnetic field is generated in the gap 112, and the magnetic flux density normal to the gap (and the sensing portion of the sensors 108) varies in magnitude in a sinusoidal manner around the gap circumference. The frequency of this sinusoidal variation is equal to one-half the number of magnetic poles. To illustrate this more clearly, FIG. 5 shows the magnetic flux field through various components of the position sensing system 100 when the system 100 includes the magnet 104 shown in FIG. 3A (e.g., includes a single, ring-shaped, 2-pole permanent magnet 104 that is magnetized across its diameter), and FIG. 6 graphically depicts how the magnetic flux density magnitude 602 normal to the gap 112 varies with position around the gap circumference for this particular system configuration. For additional clarity, FIG. 6 also depicts how the magnetic flux density magnitude 604 normal to the gap 112 varies with position around the gap circumference for a system 400 configured as shown in FIG. 4. As can be seen, the frequency of the sinusoidal variation in magnetic flux density 604 for the system configured as in FIG. 4 is twice that 602 for the system configured as in FIG. 1.

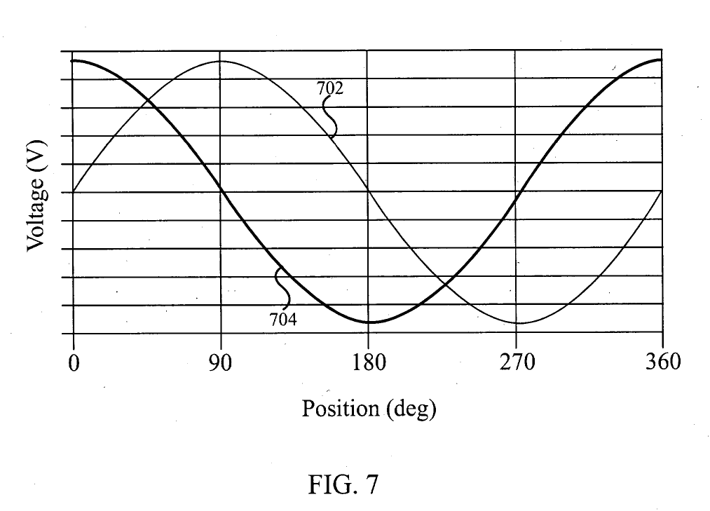

The sensors 108, as was noted above, are sensitive to variations in magnetic flux density. Thus, each sensor 108 will generate a signal having a magnitude that is proportional to magnetic field flux magnitude at its position, which is in turn proportional to the angular position (θᵣ). It will be appreciated that the signal generated by each sensor 108 could be either an AC signal, if there is relative motion between the rotor 102 and stator, or a DC signal, if there is no relative motion. As was additionally noted above, the first 108a and second 108b sensors of a sensor pair are preferably positioned in space quadrature with respect to one another. Thus, the signals generated by the first 108a and second 108b sensor of each sensor pair is proportional to the sine of the angular rotor position (sin θᵣ) and the cosine of the angular rotor position (cos θᵣ), respectively. An exemplary pair of AC signals generated by the sensors 108 of the system of FIG. 1 is shown in FIG. 7, and clearly shows that the AC signal 702 generated by the first sensor 108a is 90-degrees out of phase with the AC signal 704 generated by the second sensor 108b.

Because the AC signals 702 and 704 generated by the first 108a and second 108b sensors, respectively, of a sensor pair are 90-degrees out of phase, the following trigonometric relationship can be used to determine rotor angular position (θᵣ):

$$tan x = \frac{sin x}{cos x} . \qquad ( 1 )$$

Specifically, because the voltage magnitude (V₁) of the first AC signal 702 is proportional to sin θᵣ, and the voltage magnitude (V₂) of the second AC signal 704 is proportional to cos θᵣ, the rotor angle can be determined according to:

$${θ}_{r} = arc tan ( \frac{{V}_{1}}{{V}_{2}} ) . \qquad ( 2 )$$

Returning once again to FIG. 1, a processor circuit 118 is shown coupled to receive the signals generated by the first 108a and second 108b sensors. The processor circuit 118 may include on-board RAM (random access memory) 120, and on-board ROM (read only memory) 122. The processor circuit 118 may be any one of numerous known general purpose microprocessors or an application specific processor that operates in response to program instructions. Such program instructions may be stored in either or both the RAM 120 and the ROM 122. For example, the operating system software may be stored in the ROM 122, whereas various operating mode software routines and various operational parameters may be stored in the RAM 120. It will be appreciated that this is merely exemplary of one scheme for storing operating software and software routines, and that various other storage schemes may be implemented. It will also be appreciated that the processor circuit 118 may be implemented using various other circuits, not just a programmable processor/microprocessor. For example, digital logic circuits and analog signal processing circuits could also be used.

The processor circuit 118 may also include one or more on-board analog-to-digital (A/D) converters 124, which function to convert the signals supplied from the first 108a and second 108b sensors into digital sensor data. It will be appreciated that the A/D converter(s) 124 need not be on-board circuits, but could also be implemented as one or more individual circuits separate from the processor circuit 118. The processor circuit 118 receives the digital sensor data from the A/D converter(s) 124, and uses the data to determine rotor angular position (θᵣ). The processor circuit 118 may do this in any one of numerous ways. For example, the processor 118 could store a look-up table of sine and cosine function values in a memory, which could form part of the processor circuit 118, the RAM 120, or ROM 122, or could be a physically separate memory. With this implementation, the processor circuit 118 retrieves appropriate sine and cosine values from the look-up table based, on the digital sensor data, and then plugs the retrieved values into equation (2) to determine rotor angular position (θᵣ). In an alternative implementation, a look-up table could be generated and stored that explicitly relates the digital sensor data to rotor angular position (θᵣ).

The position sensing system 100 described above may be used in numerous and varied systems to determine the relative rotational position of a rotating element. For example, the system 100 may be used to detect the position of a rotor in a brushless DC motor. Moreover, while the magnet 104 is depicted and described above as being coupled to the rotor 102, it will be appreciated that the magnet 104 could also be coupled to the stator 106, while the sensors 108 are coupled to the rotor 102.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A rotational position sensing system, comprising:
a rotor having at least an outer surface;
a stator having at least an inner surface and surrounding at least a portion of the rotor outer surface, the stator inner surface spaced-apart from the rotor outer surface to form a gap therebetween;
one or more magnets coupled to, and circumscribing at least a section of, one of the rotor outer surface and the stator inner surface, to thereby generate a magnetic field in the gap; and
at least two magnetic field sensors disposed at least partially in the gap and positioned at a predetermined angle relative to one another.

2. The system of claim 1, wherein each magnetic field sensor is operable to supply a voltage signal having a magnitude that is proportional to magnetic field flux magnitude at its position.

3. The system of claim 2, further comprising:
a processor coupled to receive each of the voltage signals and operable, in response thereto, to determine a rotational position of the rotor relative to the stator.

4. The system of claim 3, wherein the magnetic field sensors comprise one or more pairs of magnetic field sensors and wherein:
a first magnetic field sensor of each pair is operable to supply a first signal having a magnitude that is proportional to magnetic field flux magnitude at its position; and
a second magnetic field sensor of each pair is operable to supply a second signal that is proportional to the magnetic field flux magnitude at its position and is positioned such that the second signal is 90-degrees degrees out of phase with the first signal.

5. The system of claim 4, wherein:
the processor circuit determines the rotational position of the rotor relative to the stator based on a ratio of the first voltage signal magnitude and the second voltage signal magnitude supplied from each magnetic field sensor pair.

6. The system of claim 1 wherein each magnet is a permanent magnet.

7. The system of claim 1, wherein the one or more magnets comprise a single permanent magnet that is magnetized across its diameter.

8. The system of claim 1, wherein a pair of the magnetic field sensors are positioned at an angle relative to one another such that each generates a signal 90-degrees out phase with one another.

9. The system of claim 1, wherein each magnet is radially polarized.

10. The system of claim 1, wherein each magnetic sensor comprises a Hall effect sensor.

11. The system of claim 1, wherein the rotor comprises a magnetically permeable material.

12. The system of claim 1, wherein the stator comprises a magnetically permeable material.

13. The system of claim 1, wherein the one or more magnets are coupled to the rotor outer surface.

14. A rotational position sensing system, comprising:
a rotor having at least an outer surface;
a stator having at least an inner surface and surrounding at a portion of the rotor outer surface, the stator inner surface spaced-apart from the rotor outer surface to form a gap therebetween;
a permanent magnet coupled to, and circumscribing at least a section of, one of the rotor outer surface and the stator inner surface, the permanent magnet being magnetized across its diameter and generating a magnetic field in the gap; and
at least two magnetic field sensors disposed at least partially in the gap and positioned at a predetermined angle relative to one another.

15. The system of claim 14, wherein each magnetic field sensor is operable to supply a voltage signal having a magnitude that is proportional to magnetic field flux magnitude at its position.

16. The system of claim 15, further comprising:
a processor coupled to receive each of the voltage signals and operable, in response thereto, to determine a rotational position of the rotor relative to the stator.

17. The system of claim 16, wherein the magnetic field sensors comprise one or more pairs of magnetic field sensors and wherein:
a first magnetic field sensor of each pair is operable to supply a first signal having a magnitude that is proportional to magnetic field flux magnitude at its position; and
a second magnetic field sensor of each pair is operable to supply a second signal that is proportional to the magnetic field flux magnitude at its position and is positioned such that the second signal is 90-degrees degrees out of phase with the first signal.

18. The system of claim 17, wherein:
the processor circuit determines the rotational position of the rotor relative to the stator based on a ratio of the first voltage signal magnitude and the second voltage signal magnitude supplied from each magnetic field sensor pair.

19. The system of claim 14, wherein a pair of the magnetic field sensors are positioned at an angle relative to one another such that each generates a signal 90-degrees out phase with one another.

20. The system of claim 14, wherein each magnetic sensor comprises a Hall effect sensor.

21. The system of claim 14, wherein the rotor comprises a magnetically permeable material.

22. The system of claim 14, wherein the stator comprises a magnetically permeable material.

23. The system of claim 14, wherein the permanent magnet is coupled to the rotor outer surface.

24. A method of determining a rotational position of a first element relative to at least a second element, comprising:
coupling one or more magnets to, and circumscribing at least a portion of, the first element, the first element configured to rotate relative to the second element;
surrounding the magnets with the second element such that it is spaced-apart from the first element to form a gap therebetween; and
sensing magnetic field flux magnitude variations at least at two positions in the gap when the first element rotates relative to the second element.

25. The method of claim of claim 24, wherein the magnetic field flux variations at the two positions are 90-degrees out of phase with one another.

26. The method of claim 25, further comprising:
determining a ratio of the sensed magnetic field flux variations at the two positions.
